(19) United States
(12) Patent Application Publication
(10) Pub. No.: US 2026/0038386 A1
(43) Pub. Date: Feb. 5, 2026

(54) ADAPTIVE SIMULATION-BASED TRAINING SYSTEM FOR EMERGENCY RESPONDERS

(71) Applicant: Boris Mladenovski, Nashville, TN (US)

(72) Inventor: Boris Mladenovski, Nashville, TN (US)

(21) Appl. No.: 18/811,731

(22) Filed: Aug. 21, 2024

Related U.S. Application Data
(60) Provisional application No. 63/679,590, filed on Aug. 5, 2024.

(51) Int. Cl. G09B 9/00; H04M 3/51

(52) U.S. Cl. CPC G09B 9/00; H04M 3/5116

(57) ABSTRACT

A computer-implemented method for training emergency responders involves compiling caller interactions, generating caller dispositions, and assigning a disposition to a simulated interaction. The method initiates the simulated interaction through an emergency communication prompt based on the assigned disposition. The method compares emergency responder input to situational metrics associated with the disposition and generates a simulated caller output accordingly. Subsequent responder inputs are iteratively compared to adaptively generate subsequent simulated caller outputs. Trainer review inputs associated with the simulated interaction are received to modify the responder's training regimen. This method provides a dynamic and interactive training environment for emergency responders to enhance their skills and preparedness in handling various emergency scenarios.

A portion of the disclosure of this patent document contains material that is subject to copyright protection. The copyright owner has no objection to the reproduction of the patent document or the patent disclosure, as it appears in the U.S. Patent and Trademark Office (USPTO) patent file or records, but otherwise reserves all copyright rights whatsoever.

### CROSS-REFERENCES TO RELATED APPLICATIONS

This application claims the benefit of U.S. Provisional Patent Application No. 63/679,590, filed Aug. 5, 2024.

### FIELD OF THE DISCLOSURE

The present disclosure relates to the field of electronically operated simulations for teaching and training purposes, specifically to methods and systems for training an emergency responder through monitored and simulated interactions.

### BACKGROUND

Previous approaches to training emergency responders have typically involved static scenarios or scripted simulations that do not adequately prepare responders for the dynamic and unpredictable nature of real-life emergency situations. These traditional training methods often lack the ability to adapt and provide personalized feedback based on the responder's actions and decision-making processes during simulated interactions. In many cases, emergency responder training programs have relied on manual evaluation by trainers, which can be subjective and time-consuming, leading to limitations in the effectiveness of the training process.

The present disclosure addresses the problem of inadequate training for emergency responders and persons who rely on adaptive communication for public health and safety by providing dynamic, adaptive simulations. Traditional methods require extensive manual intervention and cannot scale efficiently. This present disclosure allows multiple users to train simultaneously, simulating various emotional states and scenarios to better prepare them for real-life interactions.

Some existing systems have attempted to incorporate interactive elements into emergency responder training by utilizing computer-based simulations. However, these systems have often been limited in their ability to dynamically adjust the simulated scenarios based on the responder's performance and feedback. Additionally, the generation of simulated caller outputs in response to emergency responder inputs has been relatively simplistic, lacking the complexity and adaptability needed to realistically simulate the diverse range of interactions that responders may encounter in the field.

Furthermore, while certain training programs have integrated elements of artificial intelligence and machine learning to enhance the realism of simulated scenarios, these approaches have typically focused on specific aspects of emergency response rather than providing a comprehensive training method that encompasses the full spectrum of caller interactions and responder decision-making processes. As a result, existing training methods have fallen short in delivering a truly interactive and adaptive training experience that can effectively prepare emergency responders for the challenges they may face in real-world emergency situations. However, none of these approaches have provided a comprehensive solution that combines the features described in this disclosure.

### BRIEF SUMMARY

The present disclosure provides a novel method for training emergency responders or any persons involved in de-escalation through communications with others. Specifically, the present disclosure provides a novel training method using simulated scenarios, as well as a system for implementing the training method.

The purpose of the present disclosure is to provide an adaptive simulation-based training system for persons responding to communications, including for emergency responders. The present disclosure services to provide a simulated caller or communicator depending on the specified training scenario, aiding dispatchers, police officers, or other public or private sector personnel improve their interaction and response skills by simulating various emotional and situational states and scenarios.

Aspects of apparatus, methods, and systems of the present disclosure provide a solution to the shortcomings above. In some aspects, the techniques described herein relate to a computer-implemented method of training an emergency responder, the method including: compiling a plurality of caller interactions; generating at least one caller disposition based on the plurality of caller interactions; selectively assigning a first caller disposition of the at least one caller disposition to a simulated interaction; based upon the first caller disposition, initiating the simulated interaction through an emergency communication prompt; comparing an emergency responder input to a plurality of situational metrics associated with the first caller disposition; adaptively generating a simulated caller output based on the emergency responder input as compared to the plurality of situational metrics associated with the first caller disposition; iteratively comparing each of a plurality of subsequent emergency responder inputs to the emergency responder input, the plurality of situational metrics associated with the first caller disposition, the simulated caller output, one or more of another of the plurality of subsequent emergency responder inputs, or a combination thereof; adaptively generating each of a plurality of subsequent simulated caller outputs based on the iterative comparing; receiving, from a trainer, a trainer review input associated with the simulated interaction; and modifying a training regiment of the emergency responder based upon the trainer review input.

In some aspects, the techniques described herein relate to a method, wherein compiling the plurality of caller interactions is based upon a dataset of sample caller interactions; and wherein the dataset of sample caller interactions is predetermined by the trainer.

In some aspects, the techniques described herein relate to a method, wherein generating the at least one caller disposition further includes: generating the first caller disposition based on a first portion of the plurality of caller interactions; generating an alternative caller disposition based on a second portion of the plurality of caller interactions; and wherein the first portion of the plurality of caller interactions is different than the second portion of the plurality of caller interactions.

In some aspects, the techniques described herein relate to a method, further including: generating a caller psychological parameter and a caller situational parameter from the plurality of caller interactions; and modifying one or more of the at least one caller disposition based upon the caller psychological parameter, the caller situational parameter, or a combination thereof; or modifying the simulated caller output, one or more of the plurality of subsequent simulated caller outputs, or a combination thereof based upon the caller psychological parameter, the caller situational parameter, or a combination thereof.

In some aspects, the techniques described herein relate to a method, wherein: generating the caller psychological parameter further includes generating a caller emotional state, a caller behavioral indicator, a cognition function, or a combination thereof; and generating the caller situational parameter further includes generating a caller situational awareness, a call characteristic, a social factor, or a combination thereof.

In some aspects, the techniques described herein provide a system and method that adapts and learns from user interactions, improving over time based on feedback. It simulates various scenarios and emotional states, providing dynamic training experiences. The system and method may improvise and create new scenarios, enhancing the realism and effectiveness of the training

In some aspects, the techniques described herein relate to a method, wherein selectively assigning the first caller disposition to the simulated interaction is based on a trainee-specific data profile, a predetermined trainer profile, or a randomized selection from the dataset of sample caller interactions predetermined by the trainer.

In some aspects, the techniques described herein relate to a method, further including: generating an initial simulated caller input; prior to initiating the simulated interaction, presenting the initial simulated caller input to the emergency responder; and wherein the initial simulated caller input includes a dataset associated with the first caller disposition.

In some aspects, the techniques described herein relate to a method, wherein the dataset associated with the first caller disposition includes a name indicator, a gender indicator, an ethnicity indicator, a geospatial indicator, or a combination thereof.

In some aspects, the techniques described herein relate to a method, wherein selectively assigning a first caller disposition to a simulated interaction further includes: generating a caller morality profile associated with the first caller disposition; and modifying the simulated interaction with the caller morality profile.

In some aspects, the techniques described herein relate to a method, wherein receiving the trainer review input is based on the emergency responder input, the plurality of subsequent emergency responder input, the first caller disposition, the simulated caller output, each of the plurality of subsequent simulated caller outputs, or a combination thereof.

In some aspects, the techniques described herein relate to a method, wherein receiving the trainer review input is based on at least a positive review or a negative review.

In some aspects, the techniques described herein relate to a method, further including: after receiving the trainer review, repeating the simulated interaction based on the trainer review.

In some aspects, the techniques described herein relate to a method, further including: selectively assigning a repeat caller disposition, the repeat caller disposition the same as the first caller disposition.

In some aspects, the techniques described herein relate to a method, wherein modifying the training regiment of the emergency responder further includes selectively assigning a subsequent caller disposition based on the plurality of caller interactions, the subsequent caller disposition being different from the first caller disposition.

In some aspects, the techniques described herein relate to a method, wherein generating the at least one caller disposition or selectively assigning the first caller disposition further includes: assigning a caller profile, modifying the first caller disposition based on the caller profile; and wherein the caller profile is associated with the plurality of situational metrics associated with the first caller disposition, the psychological parameter, the caller situational parameter, or a combination thereof.

In some aspects, the techniques described herein relate to a method, wherein assigning the caller profile is based on a trainee-specific data profile, a predetermined trainer profile, a randomized selection from the plurality of caller interactions predetermined by the trainer, an autonomously generated caller profile associated with the trainer review input, or a combination thereof.

Unless otherwise defined, all technical and scientific terms used herein have the same meaning as commonly understood by one of ordinary skill in the art to which this disclosure belongs. The present disclosure may be embodied in other specific forms without departing from the spirit or essential attributes thereof, and it is therefore desired that the present disclosures be considered in all aspects as illustrative and not restrictive. Any headings utilized in the description are for convenience only and no legal or limiting effect. Numerous objects, features, and advantages of the embodiments set forth herein will be readily apparent to those skilled in the art upon reading of the following disclosure when taken in conjunction with the accompanying drawings.

### BRIEF DESCRIPTION OF THE DRAWINGS

Hereinafter, various aspects of the disclosure are illustrated in more detail with reference to the drawings.

FIGS. 1A-1B illustrate an aspect of the training method 100 of the present disclosure.

FIG. 2 illustrates an aspect of the system 200 for executing the training method 100 of the present disclosure.

FIG. 3A illustrates an exemplary aspect of a default start screen 302 of the user interface 300 of the present disclosure.

FIG. 3B illustrates an exemplary aspects of the simulation start interface 316 of the present disclosure.

FIG. 3C illustrates an exemplary aspect of an incoming call interface 320 of the present disclosure.

FIG. 3D illustrates an exemplary aspect of a responder input interface 324 of the present disclosure.

FIG. 3E illustrates an exemplary aspect of a simulated caller interface 330 of the present disclosure.

FIG. 3F illustrates an exemplary aspect of a second responder input interface 336 of the present disclosure.

FIG. 3G illustrates an exemplary aspect of an interaction review interface 338 of the present disclosure.

FIG. 3H illustrates an exemplary aspect of a simulation settings interface 348 of the present disclosure.

FIG. 3I illustrates an aspect of a user settings panel 370 of the user interface 300 of the present disclosure.

### DETAILED DESCRIPTION

Reference will now be made in detail to aspects of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one aspect can be used with another aspect to yield a still further aspect.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary aspects of the disclosure only and is not intended as limiting the broader aspects of the present disclosure.

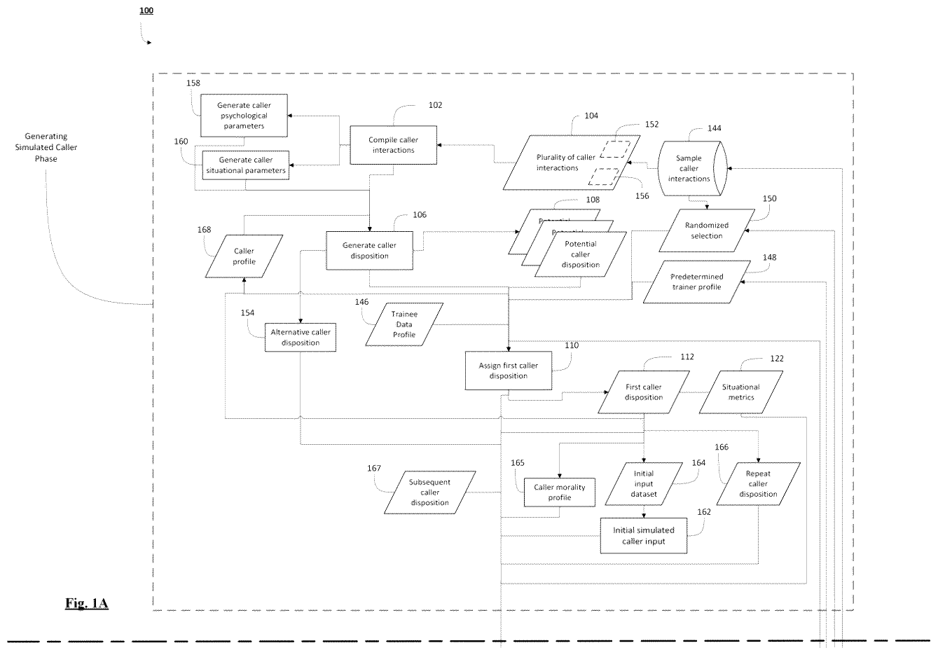

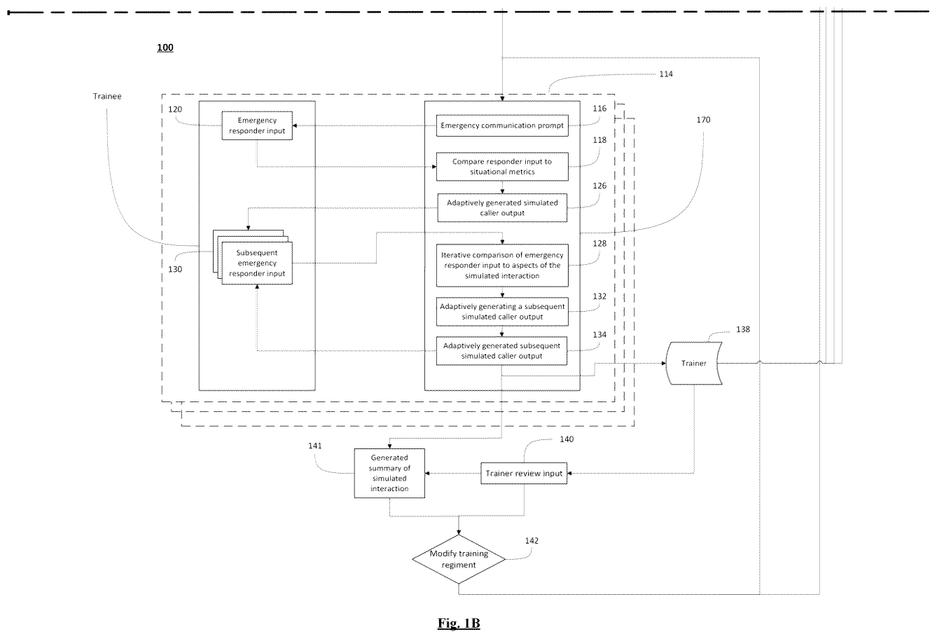

Referring generally to FIGS. 1-3 various exemplary aspects may now be described of a training method 100 for emergency responders and systems of implementation thereof. Specifically, various aspects may now be described of the training method 100 and a training system 200 for executing the training method 100. Where the various figures describe aspects sharing various common elements and features with other aspects, similar elements and features are given the same reference numerals and redundant description thereof may be omitted below.

Various aspects of a disclosure may be described below with reference to block diagrams and flowchart illustrations of methods, apparatus (i.e., systems) and computer program products (i.e., computer executable instruction modules). It will be understood by one of skill in the art that each block of the block diagrams and the flowchart illustrations, and combinations of blocks in the block diagrams and combinations of the blocks in the flowchart illustrations, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks of the flowchart, or block or blocks of the diagrams.

Accordingly, blocks of the block diagrams and the flowchart illustrations support combinations of means for performing the specified functions, combinations of steps for performing the specified functions and program instructions or modules for performing the specified functions. It will also be understood that each block of the block diagrams and the flowchart illustrations, and combinations of the respective blocks, can be implemented by special purpose hardware-based computer systems which perform the specified functions or steps, or combinations of special purpose hardware and computer instructions.

Within the scope of this disclosure, an “emergency responder” may include any individual, group of individuals, or group entity who is first to respond to emergency situations, responsible for providing critical assistance, managing crises, and ensuring public safety. This includes professionals across a spectrum of disciplines and responsibilities, such as medical personnel (EMTs and paramedics), fire service professionals, law enforcement officers (police and sheriffs), and other specialized response units that might operate under national security, public health, or environmental protection mandates. The meaning of an emergency responder may be inclusive of various levels and types of responders, from local community safety officers to national agency operatives who might deal with national security incidents, large-scale disasters, or complex emergencies that require coordination across multiple jurisdictions and specialties. An emergency responder may also encompass members of secretive agencies who handle sensitive and classified emergencies, requiring specialized training and response protocols that are tailored to their unique operational environments.

FIGS. 1A-1B illustrate an aspect of the training method 100 of the present disclosure. In some aspects, the training method 100 may begin with a step of compiling 102 a plurality of caller interactions 104. The plurality of caller interactions 104 may provide a database of example color interactions between callers and persons responding to the callers. The plurality of caller interactions 104 may include both past real recorded call our interactions and artificially generated color interactions. The plurality of caller interactions 104 may be tailored according to a number of parameters and characteristics associated with the training. In an exemplary aspect, the plurality of caller interactions 104 may be based on a geolocation, a set of scenarios as described further herein, a set of characteristics associated with the caller, or any parameter deemed relevant for purposes of the training method 100 as set by a trainer 138.

In some aspects, the step of compiling 102 the plurality of caller interactions 104 may be based on a dataset of sample caller interactions 144. The sample caller interactions 144 may include a set of real caller transcripts provided from previous interactions between callers and persons responding to calls. In some aspects, the sample caller interactions 144 may include sample interactions based on a geolocation, a disposition of the caller to be implemented in the simulated interaction 114, a type of emergency situation, or any parameter determined by the trainer 138 to be relevant to the training method 100. In some aspects, the sample caller interactions 144 may be predetermined by the trainer 138. The trainer 138 may determine a set of characteristics to be associated with the sample caller interactions 144 in a manner to define the available set of example interaction that are available for the training method 100 and available to provide the plurality of caller interactions 104.

In some aspects, the training method 100 may include generating a caller psychological parameter 158 and a caller situational parameter 160 from the plurality of caller interactions 104. The caller psychological parameter 158 may include the mental and emotional characteristics associated with the simulated caller 170, which can influence how the simulated caller 170 communicates in the simulated interaction 114. In some aspects, the caller psychological parameter 158 may include an emotional state, cognitive ability expressed as a cognition function, stress level, personality traits, mental health status, cultural background, or a combination thereof. These aspects of the caller psychological parameter 158 may be generally categorized as a caller emotional state, a caller behavioral indicator, and a cognition function. In an exemplary aspect, the caller psychological parameter 158 may include an emotion state ranging from calm, to anxious, to distressed, to angry, to panicked and may influence the ability of the simulated caller 170 to clearly communicate the situation. In an exemplary aspect, the cognitive ability may involve the capacity of the simulated caller 170 to process information and respond to the emergency responder input 120 and the subsequent emergency responder input 130; the cognitive ability may be affected by stress, substance use, or mental health conditions which may be included in the caller psychological parameter 158. The stress level may impair the communication and reasoning of the simulated caller 170, making is difficult for the simulated caller 170 to follow instructions from the trainee provided in the emergency responder input 120 or the subsequent emergency responder input 130. The personality traits may include aspects of aggressiveness, submissiveness, or assertiveness that may influence the simulated interaction 114 and how the simulated caller 170 interacts with the trainee. The mental health status may include aspects such as depression, psychosis, dementia, or others that may affect the perceptions and communications of the simulated caller 170. The cultural background may influence communication styles, perceptions of authority, and responses to crisis situations.

The caller situational parameter 160 may include specific circumstances or environment from which the simulated caller 170 is calling. In an exemplary aspect, the caller situational parameter 160 may include type of emergency, urgency of the situation, environmental conditions, presence of others, location specifics, history of the incident, or combinations thereof. These aspects of the caller situational parameter 160 may be generally categorized as a caller situational awareness, a call characteristic, a social factor. The type of emergency includes categories such as medical emergencies, fires, crimes, or accidents, which dictate the urgency and response requirements. The urgency of the situation reflects how critical it is and influences the dispatcher's prioritization and response strategies. Environmental conditions encompass factors such as noise levels, weather conditions, and the time of day, which can affect the caller's situation and the dispatcher's ability to gather information. The presence of others includes bystanders, perpetrators, or additional victims, which can impact the scenario. Location specifics involve whether the caller is in a public place, at home, or in a moving vehicle, each of which presents unique challenges and requires specific information. The history of the incident provides background information on what led up to the emergency call, influencing the context and decision-making process.

In some aspects, the training method 100 may include modifying one or more of the at least one caller disposition 108 based on the caller psychological parameter 158, the caller situational parameter 160, or a combination thereof. The at least one caller disposition 108 modified with the caller psychological parameter 158 and/or the caller situational parameter 160 may provide the first caller disposition 112 as similarly modified by the caller psychological parameter 158 and the caller situational parameter 160. In some aspects, the plurality of situational metrics 122 associated with the first caller disposition 112 may further reflect aspects of the caller psychological parameter 158 and/or the caller situational parameter 160.

In some aspects, the training method 100 may include modifying the emergency communication prompt 116, the simulated caller output 126, the subsequent simulated caller output 134, or a combination thereof based on the caller psychological parameter 158, the caller situational parameter 160, or a combination thereof. As described above, the caller psychological parameter 158 and/or the caller situational parameter 160 may modify particular aspects of the simulated interaction 114 to influence how the simulated caller 170 responds to the emergency responder input 120 and the subsequent emergency responder input 130 from the trainee. Measured aspects from the caller psychological parameter 158 and/or the caller situational parameter 160 may be included in the summary 141 of the simulated interaction 114 and similarly accounted for in the step of modifying 142 the training regiment 143 as described further herein.

The training method 100 may further include a step of generating 106 at least one caller disposition 108 based on the plurality of caller interactions 104. The plurality of caller interactions 104 may serve as a pool of selectable exemplary caller interactions from which the at least one caller disposition 108 is generated. The at least one caller disposition 108 may form the basis of a set of characteristics associated with a simulated caller 170 and may further influence the manner in which the simulated caller 170 adaptively generates outputs in response to conversational inputs from a trainee.

Generating 106 the at least one caller disposition 108 may use conversational inputs from the plurality of caller interactions 104 which may be strictly translated to the at least one caller disposition 108 or which may be adapted and transformed to contribute to a parameter associated with the at least one caller disposition 108. In an exemplary aspect, generating 106 the at least one caller disposition 108 may include selecting pertinent portions of conversation recognized in the plurality of caller interactions 104 as relevant to any particular simulated interaction and import those pertinent portions to form the at least one caller disposition 108 without significant transformation or alteration. Generating 106 the at least one caller disposition 108 may further include transforming data from the plurality of caller interactions 104, including recognizing certain patterns, terminology, exemplary conversations, or other parameters associated with the plurality of caller interactions 104 that may be utilized in a simulated interaction 114 with a trainee.

The at least one caller disposition 108 may include any number of selectable caller dispositions. In some aspects, the number of caller dispositions may be predefined by the trainer 138, an administrator of the system, predetermined by a particular training regiment, or may be determinable based on other characteristics of the training method 100 as desired.

The training method 100 may further include a step of selectively assigning 110 a first caller disposition 112 to the simulated interaction 114. In some aspects, the at least one caller disposition 108 may include the first caller disposition 112, which may provide the caller disposition used to begin the training method 100. In this manner, the first caller disposition 112 may be simply selected as an available caller disposition within the at least one caller disposition 108 and be assigned to the simulated interaction 114. In some aspects, the first caller disposition 112 may be selectively assigned 110 by modifying the at least one caller disposition 108 as will be described further herein. In some aspects, the first caller disposition 112 may provide a baseline caller disposition that may be used to establish and measure a trainee's performance according to the training method 100. In some aspects, the first caller disposition 112 may be further modified or transformed after the step of assigning 110 and before the simulated interaction 114 as described further herein.

In some aspects, the step of assigning 110 the first caller disposition 112 to the simulated interaction 114 may be based on a trainee-specific data profile 146, a predetermined trainer profile 148, or a randomized selection 150 from the sample caller interactions 144 as predetermined by the trainer 138. The trainee-specific data profile 146 may include aspects of the training regiment 143 applicable to any particular trainee in the training method 100. In some aspects, the trainee-specific data profile 146 may include determinable parameters that may influence the training method 100 of the first caller disposition 112 and any subsequent first caller disposition 112 assigned from the at least one caller disposition 108. In an exemplary aspect, the trainee-specific data profile 146 may include a training plan that includes progression of training to different caller dispositions, segments of different of the simulated interaction 114 based on different scenarios and caller profiles, and any other aspect the trainer 138 may wish to incorporate into the training method 100.

In some aspects, the predetermined trainer profile 148 may include a schedule of training progression any may otherwise provide an available set of aspects of the training method 100 to emphasize for any particular simulated interaction 114. The predetermined trainer profile 148 may provide a set schedule of training and may indicate any particular first caller disposition 112 should be assigned from the at least one caller disposition 108 based upon a certain aspect the trainer 138 would like to be the focus of in the simulated interaction 114. In some aspects, the predetermined trainer profile 148 may reflect a plan for the training method 100 and may make assumptions about the progress of the trainee and specifics of the modifying 142 of the training regiment 143.

In some aspects, the randomized selection 150 from the sample caller interactions 144 may provide the step of assigning 110 the first caller disposition 112 with a degree of randomness based on a sampling of the sample caller interactions 144. In some aspects, the randomized selection 150 may be independent and unrelated to the plurality of caller interactions 104 such that the step of assigning 110 the first caller disposition 112 may be based on both the randomized selection 150 of the sample caller interactions 144 and the plurality of caller interactions 104 separately. In some aspects, the randomized selection 150 of the sample caller interactions 144 may reflect and be based on the plurality of caller interactions 104 such that the step of assigning 110 the first caller disposition 112 adds a degree of randomness only to the extent such randomness is reflected in the plurality of caller interactions 104.

In some aspects, the step of generating 106 the at least one caller disposition 108 may include generating the first caller disposition 112 based on a first portion 152 of the plurality of caller interactions 104, generating an alternative caller disposition 154 based on a second portion 156 of the plurality of caller interactions 104, where the first portion 152 is different from the second portion 156. In this manner, the at least one caller disposition 108 may be based on the first portion 152 of the plurality of caller interactions 104 and may include characteristics, parameters, and other aspects associated with the first portion 152 of the plurality of caller interactions 104. The alternative caller disposition 154 may be based on the second portion 156 of the plurality of caller interactions 104, with the second portion 156 being different from the first portion 152. The alternative caller disposition 154 may include characteristics, parameters, and other aspects that are different than those included in the at least one caller disposition 108 and the first caller disposition 112. In some aspects, the alternative caller disposition 154 may reflect a different set of characteristics than the first caller disposition 112 or any of the at least one caller disposition 108.

In some aspects, the alternative caller disposition 154 may be assigned to the simulated interaction 114 without regard to the first caller disposition 112. The alternative caller disposition 154 may include its own set of the plurality of situational metrics 122 and may otherwise include aspects disclosed as part of the first caller disposition 112, including a trainee-specific data profile 146, a predetermined trainer profile 148, a randomized selection 150 from the sample caller interactions 144.

The simulated interaction 114 may provide a measured environment by which communication from the simulated caller 170 is initiated and being used to prompt a response from the trainee. The simulated interaction 114 may be provided in a series of simulated interactions as part of a training regiment established for the trainee, by the trainer 138, preset by program or an administrator, or otherwise part of a larger set of simulated interactions. Each simulated interaction 114 of the set may define its own measured interaction between the trainee and the simulated caller 170.

In some aspects, the step of assigning 110 the first caller disposition 112 to the simulated interaction 114 may include generating a caller morality profile 165 associated with the first caller disposition 112 and modifying the simulated interaction 114 according to the caller morality profile 165. In some aspects, the caller morality profile 165 may dictate the ethical and moral dimensions of the simulated interaction 114, influencing the emergency communication prompt 116, the comparing 118 the emergency responder input 120 to the plurality of situational metrics 122, the simulated caller output 126, the comparing 128 the subsequent emergency responder input 130 to aspects of the simulated interaction 114, the generating 132 of the subsequent simulated caller output 134, or combination thereof.

In some aspects, the caller morality profile 165 may include one or a combination of a number of different morality profiles, exemplary aspects of which are provided below. For example, callers with an altruistic profile might prioritize others' safety over their own, challenging trainees to accurately assess and prioritize needs. Egoistic callers may focus on their own well-being, exaggerating situations to receive immediate attention, which tests a trainee's ability to manage information effectively. Utilitarian callers assess situations based on the greatest good for the greatest number, requiring broader situational awareness from the dispatcher. Deontological callers adhere strictly to rules and ethics, possibly refusing certain types of help if they believe it compromises their moral beliefs, necessitating delicate navigation by trainees. Nihilistic callers may exhibit a lack of regard for life or laws, engaging in behaviors that exacerbate the situation, requiring trainees to focus on de-escalation. Empathetic callers are intensely affected by the emotions and situations of others, requiring dispatchers to engage in more supportive communication techniques. Each morality profile may shape how simulated callers might interact with trainees, influencing the complexity of communication, decision-making, and response strategies.

In some aspects, the caller morality profile 165 may be provided as simply a moral or an immoral caller morality profile 165. In some aspects, the caller morality profile 165 may combine one or more of several of the caller morality profile 165 as described herein.

In some aspects, the generating 106 the at least one caller disposition 108 or selectively assigning 110 the first caller disposition 112 may include assigning a caller profile 168 associated with the caller psychological parameter 158, the caller situational parameter 160, the plurality of situational metrics 122, or a combination thereof. The training method 100 may further include modifying the first caller disposition 112 or the at least one caller disposition 108 with the caller profile 168.

In some aspects, assigning the caller profile 168 may be based on the trainee-specific data profile 146, the predetermined trainer profile 148, the randomized selection 150 of the sample caller interactions 144 or randomized selection 150 of the plurality of caller interactions 104, or autonomously generated caller profile associated with the trainer review input 140, or a combination thereof. In some aspects, the subsequent caller disposition 167 may provide the autonomously generated caller profile associated with the trainer review input 140 as described herein.

The training method 100 may further include a step of initiating the simulated interaction 114 through an emergency communication prompt 116. The emergency communication n prompt 116 may include an initial simulated communication from the simulated caller 170 and may provide information to begin the measured simulated interaction 114. The emergency communication prompt 116 may include a simple call opening simulated a caller contacting emergency services or whichever service may be applicable to the training method 100. The emergency communication prompt 116 may further include information about the nature of the simulated interaction 114, including particular situational or caller characteristics and information relevant to the interaction between the trainee and the simulated caller 170. In an exemplary aspect, the emergency communication prompt 116 may include the nature of the simulated emergency situation, geolocation information associated with the nature of the simulated interaction 114, any immediate need or danger information, information associated with a generated emotional state associated with the simulated caller 170, background information like background sounds associated with the environment associated with the simulated interaction 114 or the simulated caller 170, and brief caller information that may indicate an identity or brief personal detail associated with the simulated caller 170.

In some aspects, the training method 100 may include generating an initial simulated caller input 162 and presenting the initial simulated caller input 162 to the emergency responder trainee prior to initiating the simulated interaction 114 with the emergency communication prompt 116. The initial simulated caller input 162 may include and be based on an initial input dataset 164 associated with the first caller disposition 112. The initial input dataset 164 may include various identifiers attributable to and associated with the first caller disposition 112. In some aspects, the initial input dataset 164 may include information conventionally associated with a caller ID or other initial information that may be prompted to persons responding to calls. In an exemplary aspect, the initial input dataset 164 may include details related to the geolocation, the time, the situational awareness, details associated with the demographics of the simulated caller 170, and other details that the trainer 138 may want to present to the trainee before the trainee receives the emergency communication prompt 116. In some aspects, the initial input dataset 164 may include a name indicator, a gender indicator, an ethnicity indicator, a geospatial indicator, or a combination thereof. The trainee may view the initial simulated caller input 162 before initiating the simulated interaction 114 and receiving the emergency communication prompt 116. In some aspects, the initial simulated caller input 162 provides an initial set of information to the trainee to influence the emergency responder input 120 to the emergency communication prompt 116 and other communications within the simulated interaction 114.

In some aspects, the simulated interaction 114 may continue after the emergency communication prompt 116 with an emergency responder input 120 that is in some manner responsive to the emergency communication prompt 116 or some other aspect associated with the simulated interaction 114. The emergency responder input 120 may be generated by the trainee through their applicable terminal device discussed further herein. In some aspects, the trainee may be prompted to provide the emergency responder input 120, which may include an available set of predefined inputs and/or may include an open-ended responsive input field allowing the trainee to input any tailored. In some aspects, the trainee may be prompted with an initial prompt of whether or not to respond to the emergency communication prompt 116 or any output from the simulated caller 170 such that the trainee will need to first indicate an option to respond before the simulated interaction 114 may receive the emergency responder input 120 which is responsive to the emergency communication prompt 116.

The training method 100 may further include a step of comparing 118 the emergency responder input 120 to a plurality of situational metrics 122 associated with the first caller disposition 112. Once the simulated caller 170 has received the emergency responder input 120, the simulated caller 170 and simulated interaction 114 may compare the emergency responder input 120 to the plurality of situational metrics 122 to generate a simulated caller output 126. The plurality of situational metrics 122 may be associated with the first caller disposition 112 and may indicate various attributes associated with the simulated caller 170 that will influence the simulated caller output 126.

In some aspects, the plurality of situational metrics 122 may include information associated with a simulated situation associated with the first caller disposition 112, including various example scenarios. In an exemplary aspect, the plurality of situational metrics 122 may provide information including the generated environment of the simulated caller 170 that may influence the outputs of the simulated caller 170. The simulated interaction 114 may provide the simulated caller 170 is calling from a domestic violence environment, a bystander environment, a hostage environment, a road rage environment, or any environment situation that may be intended for use in the training method 100. The plurality of situational metrics 122 may indicate a stress level to be attributed to the simulated interaction 114 and may simulate various background information present throughout the simulated interaction 114 that may continue to influence any outputs from the simulated caller 170 in response to emergency responder input 120. In some aspects, the plurality of situational metrics 122 may be associated directly with the plurality of caller interactions 104, may be attributable to any one of the at least one caller disposition 108, may be predefined by the trainer 138, or may be determinable based on any particular simulated interaction 114 of the training method 100.

The step of comparing 118 the emergency responder input 120 to the plurality of situational metrics 122 associated with the first caller disposition 112 may include determining how the emergency responder input 120 addresses the plurality of situational metrics 122 and how the plurality of situational metrics 122 impact the emergency communication prompt 116, the simulated caller output 126, and any subsequently generated simulated caller output. In an exemplary aspect, the plurality of situational metrics 122 may indicate to the trainee through the emergency communication prompt 116 an associated stress level environment associated with the first caller disposition 112. The step of comparing 118 the emergency responder input 120 to the plurality of situational metrics 122 may include a determination of the degree to which the emergency responder input 120 acknowledged or accounted for the stress level associated with the plurality of situational metrics 122 and the first caller disposition 112. The step of comparing 118 the emergency responder input 120 to the plurality of situational metrics 122 may further include assigning an output parameter to account for how the emergency responder input 120 acknowledged and addressed the plurality of situational metrics 122.

The training method 100 may further include a step of adaptively generating 124 the simulated caller output 126 based on the emergency responder input 120 as compared to the plurality of situational metrics 122 associated with the first caller disposition 112. Adaptively generating 124 the simulated caller output 126 may be based on the comparing 118 of the plurality of situational metrics 122 associated with the first caller disposition 112 to the emergency responder input 120. In some aspects, adaptively generating 124 the simulated caller output 126 will be directly responsive to the emergency responder input 120 and may address the emergency responder input 120 directly. In some aspects, adaptively generating 124 the simulated caller output 126 may ignore the emergency responder input 120 and may generate the simulated caller output 126 without regard to the emergency responder input 120. The simulated caller output 126 may be transmitted to the trainee through the simulated interaction 114 and from the simulated caller 170 to continue the simulated interaction 114.

In some aspects, the step of adaptively generating 124 the simulated caller output 126 and the subsequent simulated caller output 134 as discussed further herein may adaptively attribute weights, hierarchies, or otherwise prioritize certain aspects of inputs that influence that simulated caller output 126 and subsequent simulated caller output 134 of the simulated interaction 114. In an exemplary aspect, the simulated caller output 126 may be based on the first caller disposition 112 and the plurality of situational metrics 122, but the simulated caller 170 may attribute greater weight to the caller morality profile 165, the caller profile 168, or other inputs in generating the simulated caller output 126 or the subsequent simulated caller output 134.

Once the simulated caller output 126 is provided to the trainee, the trainee may respond by generating a subsequent emergency responder input 130 in a manner similar to how the trainee provided the emergency responder input 120, including being prompted to respond to the simulated caller output 126, responding to the simulated caller output 126 with an open and/or closed nature response, and transmitting the subsequent emergency responder input 130 to the simulated caller 170. In the simulated interaction 114, the subsequent emergency responder input 130 may be one of a plurality of the subsequent emergency responder input 130, each of the subsequent emergency responder input 130 responsive to a simulated caller output 126 from the simulated caller 170.

The training method 100 may include, as part of the simulated interaction 114, a step of iteratively comparing 128 each of the plurality of the subsequent emergency responder input 130 to the emergency responder input 120, the plurality of situational metrics 122 associated with the first caller disposition 112, the simulated caller output 126, one or more of another of the plurality of the subsequent emergency responder input 130, or a combination thereof. The step of iteratively comparing 128 the subsequent emergency responder input 130 to a number of parameters provides in part the step of adaptively generating 132 a subsequent simulated caller output 134.

In some aspects, the step of iteratively comparing 128 each of the subsequent emergency responder input 130 to the emergency responder input 120 may include determining whether the subsequent emergency responder input 130 accounted for the substance of the emergency responder input 120, including whether the subsequent emergency responder input 130 continued to respond in a manner and substance similar to the emergency responder input 120 or whether the subsequent emergency responder input 130 represents a divergence from the manner and substance of the emergency responder input 120.

In some aspects, the step of iteratively comparing 128 each of the subsequent emergency responder input 130 to the plurality of situational metrics 122 associated with the first caller disposition 112 may be in a manner similar to the step of comparing 118 the emergency responder input 120 to the first caller disposition 112, including determining the extent to which the subsequent emergency responder input 130 addresses the stress level and other parameters associated with the first caller disposition 112 and the plurality of situational metrics 122 attributed to the first caller disposition 112. The step of iteratively comparing 128 each of the subsequent emergency responder input 130 to the plurality of situational metrics 122 may include further modifying the subsequent simulated caller output 134 based on the plurality of situational metrics 122 such that the subsequent simulated caller output 134 may be not only responsive to the subsequent emergency responder input 130 but may also expand upon effects of the plurality of situational metrics 122 on the first caller disposition 112.

In some aspects, the step of iteratively comparing 128 each of the subsequent emergency responder input 130 to the simulated caller output 126 may include determining how responsive the subsequent emergency responder input 130 was to the simulated caller output 126 and other aspects of how the subsequent emergency responder input 130 accounted for the simulated caller output 126. In an exemplary aspect, the step of iteratively comparing 128 the subsequent emergency responder input 130 to the simulated caller output 126 may include determining whether the subsequent emergency responder input 130 adequately responded to the simulated caller output 126 in a manner to further the simulated interaction 114. In the instance, where the subsequent emergency responder input 130 did not adequately respond to the simulated caller output 126 to further the simulated interaction 114, the step of iteratively comparing 128 the subsequent emergency responder input 130 to the simulated caller output 126 may include adaptively generating 132 the subsequent simulated caller output 134 to acknowledge the subsequent emergency responder input 130 did not adequately respond to the simulated caller output 126. In an exemplary aspect, the step of iteratively comparing 128 the subsequent emergency responder input 130 to the simulated caller output 126 and determining the subsequent emergency responder input 130 did not provide an adequately responsive response may include terminating the simulated interaction 114.

In some aspects, the step of iteratively comparing 128 the subsequent emergency responder input 130 to one or more of another of the plurality of the subsequent emergency responder input 130 may include determining the difference between the subsequent emergency responder input 130 and another of the plurality of the subsequent emergency responder input 130 and determining the effect of those differences in furthering the simulated interaction 114 according to any particular goals or parameters associated with the simulated interaction 114 or the training method 100. The step of iteratively comparing 128 the subsequent emergency responder input 130 to one or more of another of the plurality of the subsequent emergency responder input 130 may include determining an overall tone and approach associated with the trainee according to the simulated interaction 114 and may further characterize the trainee approach through the emergency responder input 120 and the subsequent emergency responder input 130.

The training method 100 may further include a step of adaptively generating 132 each of a plurality of the subsequent simulated caller output 134 based on the step of iteratively comparing 128 the subsequent emergency responder input 130 to any number of parameters associated with the simulated interaction 114 and/or the first caller disposition 112. The comparison of the subsequent emergency responder input 130 to the emergency responder input 120, the plurality of situational metrics 122 associated with the plurality of situational metrics 122 may include a comparison of the emergency responder input 120 to the subsequent simulated caller output 134. The step of adaptively generating 132 each of the plurality of the subsequent simulated caller output 134 based on the comparing 128 may include evaluating the subsequent emergency responder input 130 in the same manner as the emergency responder input 120 and iteratively comparing 128 the emergency responder input 120 to a number of parameters associated with the emergency responder input 120, the plurality of situational metrics 122 associated with the first caller disposition 112, the simulated caller output 126, one or more of the plurality of the subsequent emergency responder input 130 as described above.

The training method 100 may further include a step of receiving 136 from the trainer 138 a trainer review input 140 associated with the simulated interaction 114. In some aspects, the trainer review input 140 may be associated with the emergency responder input 120 and the subsequent emergency responder input 130 as compared to the first caller disposition 112 and the plurality of situational metrics 122 associated with the first caller disposition 112. The trainer review input 140 may provide a portion associated with the simulated interaction 114 and may be based in part on the emergency communication prompt 116, the emergency responder input 120, the simulated caller output 126, the subsequent emergency responder input 130, the subsequent simulated caller output 134, or a combination thereof. The trainer review input 140 may be provided as a binary form of feedback regarding the simulated interaction 114, including a form of feedback associated with the simulated interaction 114 as a whole.

The present method and system may adapt to the specific needs and data for each training site, improving the efficiency, speed, and reliability of training, and allow multiple trainees to interact simultaneously with individualized scenarios. The present method and system may also increase efficiency, speed, and reliability in the training method 100 of responders and other public service personnel. The present method and system may enable the trainer 138 to handle large groups simultaneously and provides individualized and realistic training scenarios.

The trainer review input 140 may indicate a variety of options related to the simulated interaction 114, including modifying the training method 100 according to the simulated interaction 114. In an exemplary aspect, the trainer review input 140 may indicate an action to repeat the simulated interaction 114, alter the training method 100 according to a parameter associated with the trainer review input 140.

In some aspects, the trainer review input 140 may be based on the emergency responder input 120, the subsequent emergency responder input 130, the first caller disposition 112, the simulated caller output 126, the subsequent simulated caller output 134, or a combination thereof.

In some aspects, the simulated interaction 114 may output a summary 141 of the simulated interaction 114. The simulated interaction 114 may provide the summary 141 based on the emergency communication prompt 116, the emergency responder input 120, the simulated caller output 126, the subsequent emergency responder input 130, each of the subsequent simulated caller output 134 associated with the simulated interaction 114, and any combination thereof.

In some aspects, the training method 100 may include a step of modifying 142 a training regiment 143 of the trainee and emergency responder based on the trainer review input 140. The step of modifying 142 the training regiment 143 may include consideration of the trainer review input 140, the summary 141, or any other measurement associated with the simulated interaction 114. The step of modifying 142 the training regiment 143 may further include input from the trainer 138 associated with to the simulated interaction 114, or any other feedback provided by the simulated interaction 114. In some aspects, the trainer review input 140 may include binary feedback, including a positive “thumbs-up” and negative “thumbs-down” input. In some aspects, the trainer review input 140 may further include feedback options that allow for any text, voice, video, or multimedia feedback from the trainer 138. The trainer review input 140 may further include instructions to modifying 142 the training regiment 143 as described further herein. In some aspects, the step of modifying 142 the training regiment 143 may be based on the summary 141 of the simulated interaction 114 without the trainer review input 140.

In some aspects, the step of modifying 142 the training regiment 143 may include repeating the simulated interaction 114 without modifying the first caller disposition 112 or the plurality of situational metrics 122 associated with the first caller disposition 112 or any other parameter associated with the first caller disposition 112. In some aspects, the step of modifying 142 the training regiment 143 may include repeating the training method 100 at the step of assigning 110 the first caller disposition 112 from the at least one caller disposition 108. The step of assigning 110 the first caller disposition 112 may include assigning 110 a different of the at least one caller disposition 108 to be used in the simulated interaction 114. Assigning 110 a different of the at least one caller disposition 108 to the first caller disposition 112 may include the same plurality of situational metrics 122 associated with the first caller disposition 112 as used before the step of modifying 142 the training regiment 143, or the step of assigning 110 a different of the at least one caller disposition 108 to the first caller disposition 112 may include a new set of plurality of situational metrics 122 to be associated in response to the modifying 142 of the training regiment 143.

In some aspects, the step of modifying 142 the training regiment 143 may include repeating the simulated interaction 114 based on the trainer review input 140. In this manner, the trainer review input 140 may indicate certain modifications of the repeated simulated interaction 114 different from the previous simulated interaction 114. The trainer review input 140 may modify each of the simulated caller output 126 and the subsequent simulated caller output 134.

In some aspects, the step of modifying 142 the training regiment 143 by repeating the simulated interaction 114, including based on the trainer review input 140, may selectively assign a repeat caller disposition 166, where the repeat caller disposition 166 is the same as the first caller disposition 112. In this manner, the simulated interaction 114 may proceed similar to, and in some instances the same as, the previous simulated interaction 114.

In some aspects, the step of modifying 142 the training regiment 143 may include selectively assigning a subsequent caller disposition 167 of the at least one caller disposition 108 based on the plurality of caller interactions 104. The subsequent caller disposition 167 may be different from the first caller disposition 112. The subsequent caller disposition 167 may include parameters similarly included in the first caller disposition 112, including its own set of plurality of situational metrics 122, the initial input dataset 164, the caller morality profile 165, or a combination thereof.

The training method 100 including the modifying 142 the training regiment 143 as disclosed above may enable scalable and adaptive training for emergency responders, public service personnel, and others training to respond to emergency communications. The training method 100 has the advantage of preparing a diverse base of persons for a wide range of scenarios, improving response and interaction skills.

The practical effect of the training method 100 and associated system 200 may provide simulation of various roles of persons for training responsive personnel, with the simulated roles including various examples of distressed callers, suspects, or victims. By authentically simulating roles that may otherwise be difficult to replicate or simulate, the training method 100 and associated system 200 provide a practical training tools for emergency response organizations, including law enforcement, fire departments, governmental institutions and the like. The training method 100 may be used to create realistic training experiences, such as dispatch training for handling distressed callers, police interrogation scenarios, and fire emergency drills. The ability of the training method 100 to simulate a wide range of emotional states, generate unique scenarios on the fly, and handle multiple trainees simultaneously provides realistic and adaptive training that would be challenging for humans to replicate. This involves processing sample datasets, learning from user interactions, generating new scenarios, and using real-time feedback to enhance training effectiveness through a Retrieval-Augmented Generation (RAG) method.

The training method 100 and associated system 200 may provide the inventive concept of simulating a wide range of emotional states and create unique, on-the-fly scenarios, enhanced by a toggleable morality engine. This engine enables dynamic and realistic training scenarios, distinguishing the training method 100 from existing technologies. The training method 100 and associated system 200 may provide practical training for emergency responders and public service personnel by adapting and learning from interactions, thus offering a dynamic and scalable training solution that traditional methods lack. The training method 100 and system 200 continuously evolves based on user feedback, with specific inputs like sample datasets and user interactions, and outputs such as simulated scenarios and training results. These elements are crucial for generating effective training and ensuring ongoing relevance and improvement.

FIG. 2 illustrates an aspect of the system 200 for executing the training method 100 of the present disclosure. The system 200 may include an administrator 202 to manage and oversee the overall operation of the training method 100 as executed through a FORTIS 911 training platform 204. The training platform 204 may be provided as a downloadable application, a mobile web version of an application and portal, a mobile application version of an application and portal, or any means desired by persons seeking to execute the training method 100. The administrator 202 may configure system, setting, monitor training sessions, and otherwise ensure smooth system functioning. The administrator 202 may interact directly with the training platform 204.

In some aspects, the system 200 may also include a computation core 206, otherwise known as the FORTIS 911 engine. The computation core 206 may provide for various workflows for generation of the simulated caller 170. The computation core 206 may manage core training functions, including storing the simulated interaction 114, executing the training regiment 143, and interfacing with both the trainee 220 and the trainer 138. In some aspects, the computation core 206 may include functionality associated with a large language model (“LLM”) as a type of language model that has been trained on a larger data set and has a larger number of parameters (e.g., billions of parameters) compared to a regular language model. In certain aspects, an LLM can understand more complex textual inputs and generate more coherent responses due to its extensive training. In certain aspects, an LLM can use a transformer architecture that is a deep learning architecture using an attention mechanism (e.g., which inputs deserve more attention than others in certain cases). In some aspects, a language model includes an autoregressive language model, such as a Generative Pre-trained Transformer 3 (GPT-3) model, a GPT 3.5-turbo model, a Claude model, a command-xlang model, a bidirectional encoder representations from transformers (BERT) model, a pathways language model (PaLM) 2, and/or the like.

The training method 100 may use real-life scenario examples to generate simulations and may create entirely new scenarios by improvising. A training platform may interact with custom models via API calls, and backend system may use GPUs, exemplary GPUs from Nvidia (including H100, A100 series) for training and deploying the present disclosure, with such hardware handling the computational load require for real-time simulation and learning.

The system 200 may also include a caller interaction database 208, a trainee interface 210, the training regiment 212, and a trainer interface 214. The caller interaction database 208 may provide a database to store a comprehensive collection of caller interactions, including both real and artificially generated interactions. The caller interaction database 208 may be communicatively associated with the plurality of caller interactions 104 and the sample caller interactions 144.

In some aspects, the training regiment 212 may provide a module that defines the training program, including a sequence of scenarios, evaluation criteria, progression of difficulty, and other parameters that may be associated with the training method 100, including those that may be modified by the trainer 138. In some aspects, the training regiment 212 may provide a module to be operatively associated with the training regiment 143 of the training method 100.

In some aspects, the trainee interface 210 and the trainer interface 214 may provide interfaces to engage with the system 200 and execute the training method 100. The trainee interface 210 may allow a trainee 220 to engage with the system 200 and to receive and interact with the simulated interaction 114 and the simulated caller 170. The trainer interface 214 may allow the trainer 138 to configure parameters associated with the at least one caller disposition 108, the first caller disposition 112, the simulated interaction 114, the simulated caller 170, and the training method 100 as a whole. The trainer interface 214 also may allow the trainer 138 to provide the trainer review input 140 to aid in modifying 142 the training regiment 143.

The system 200 may include a data 216 to be operatively and communicatively associated with the computation core 206 and provide storage and management of certain data used by the computation core 206. In some aspects, the data used as part of executing the training method 100 may be stored at the data 216, including the plurality of caller interactions 104 and the sample caller interactions 144. The generating 106 may provide the flow of interactions and data to the computation core 206 for generating and managing the simulated interaction 114.

The system 200 may further include at least one training terminal 218, which provide devices through which the trainee 220 may interact with the trainee interface 210.

In some aspects, the system 200 may include server components such as switches, routers, chassis, GPUs, CPUs, storage servers, and client-side devices for API interactions as known in the art. The server components may host the training platform 204 and the computation core 206 while the at least one training terminal 218 and other client devices make API calls to perform the simulated interaction 114. The interaction of the components of the system 200 within the training method 100 provide the computational power and infrastructure required for real-time simulations and interactions necessitated by the training method 100.

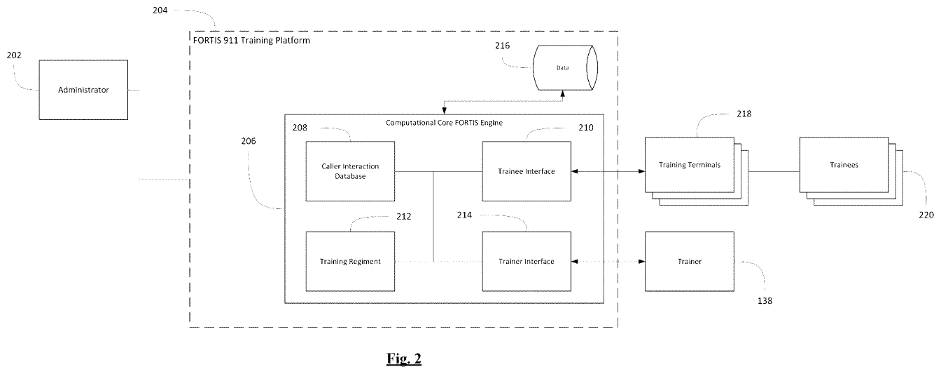

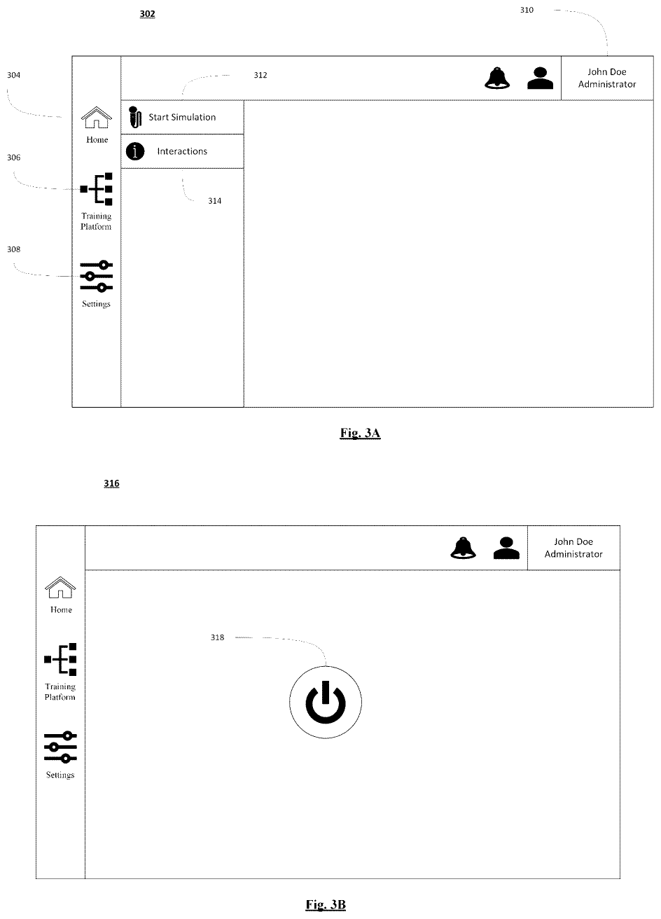

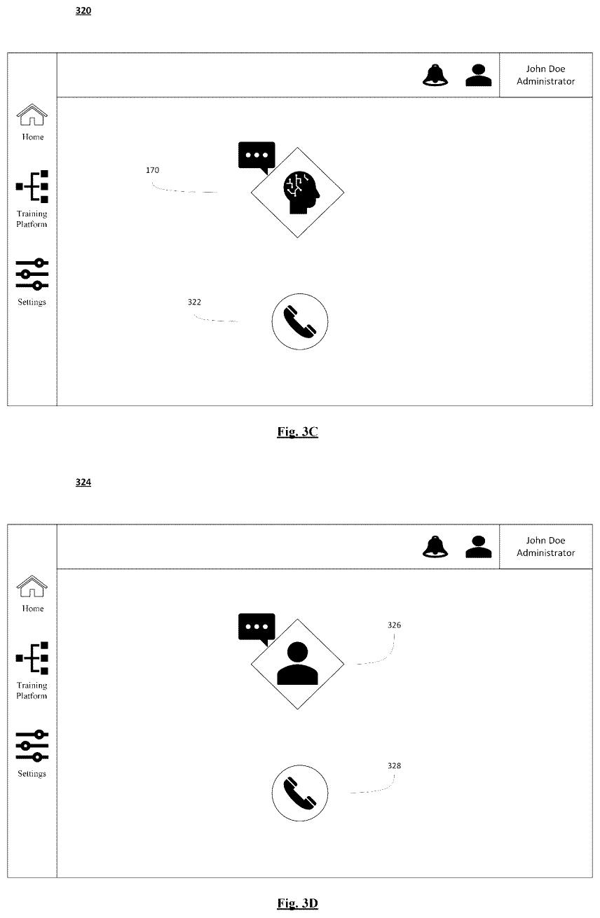

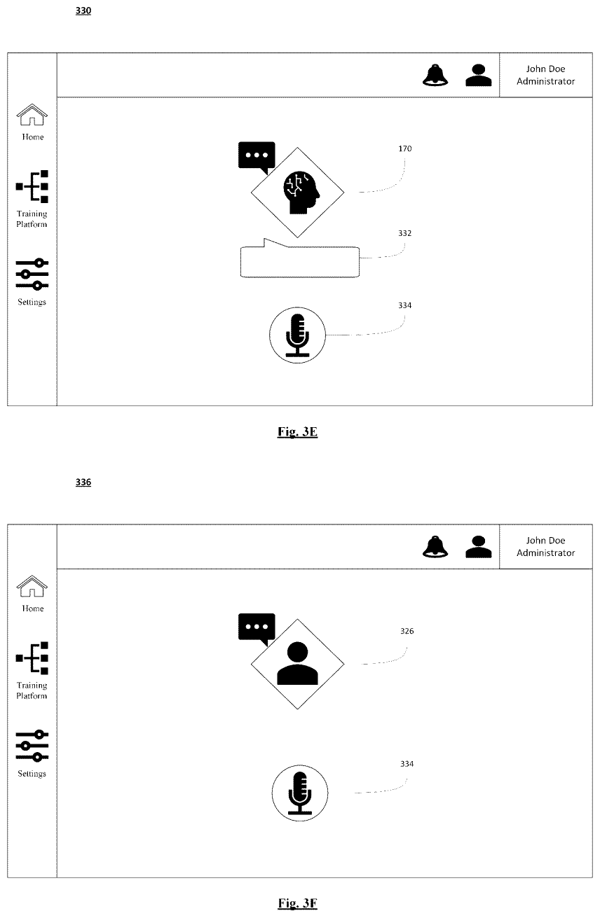

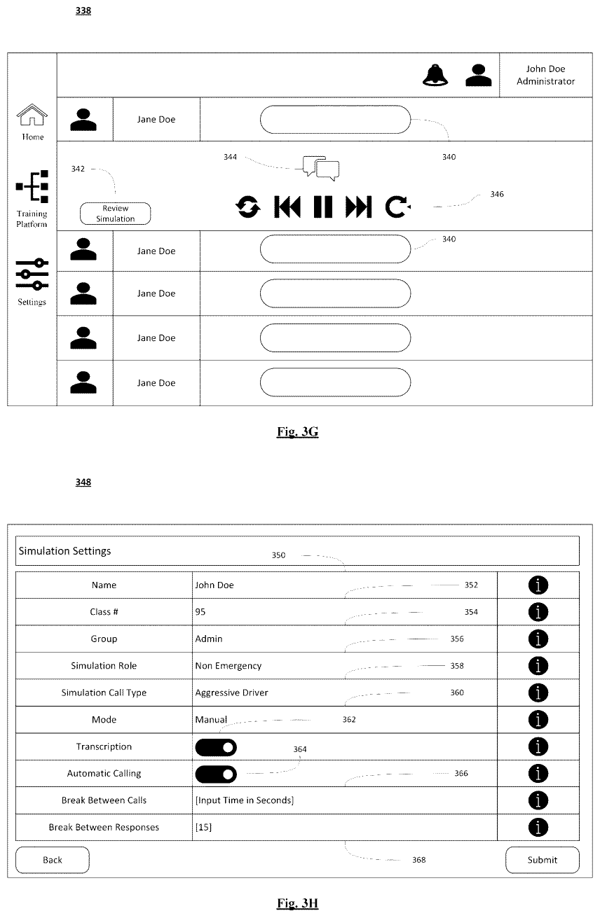

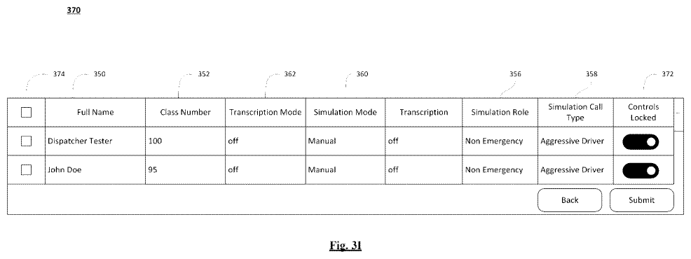

FIGS. 3A-3I illustrate an exemplary aspect of a user interface 300 settings selection. The user interface 300 may include several sub-interfaces or separate screen of interaction. Exemplary and selectable screens or interfaces may be described herein. FIG. 3A illustrates an exemplary aspect of a default start screen 302 of the user interface 300. The default start screen 302 may include various navigation options available, including a home 304 a training platform 306 and settings 308. The default start screen 302 may also be tailored for an individual user or trainee, or maybe modified based on particular role of a user, including administrator, trainer, training, etc. The default start screen 302 may indicate a user profile 310 associated with any particular training session or access to the system 200. The user profile 310 may attribute a set of parameters associated with the user interface 300, including ability to access various functions and data associated with the training method 100. In an exemplary aspect, the user profile 310 of the administrator 202 may provide full access to all system 200 features, whereas the user profile 310 associated with a trainee may provide a lesser degree of access to the system 200 features.

The default start screen 302 may also include an option to access a start simulation 312 feature and an interactions 314 feature. In an exemplary aspect, selecting the start simulation 312 feature may bring a user to a simulation start interface 316. FIG. 3B illustrates an exemplary aspects of the simulation start interface 316, which may simply prompt the user to being the simulation by selecting a begin simulation button 318.

FIG. 3C illustrates an exemplary aspect of an incoming call interface 320. After beginning the simulation with the begin simulation button 318, the incoming call interface 320 may appear to indicate that the simulated caller 170 is calling. The simulated caller 170 may be graphically represented in the incoming call interface 320 through an indicator. The indicator for the simulated caller 170 may be standardized, without distinguishing features. In some aspects, the indicator for the simulated caller 170 may be customized or selectable based on the at least one caller disposition 108 that is selected to initiate and perform the simulated interaction 114. The user may initiate the simulated interaction 114 with the simulated caller 170 through a start call button 322. In some aspects, the incoming call interface 320 may be where the initial simulated caller input 162 is provided to the user. In the incoming call interface 320, the simulated caller 170 may further provide the emergency communication prompt 116.

FIG. 3D illustrates an exemplary aspect of a responder input interface 324. The responder input interface 324 may provide the opportunity for the emergency responder input 120. The responder input interface 324 may provide a responder indicator 326 and an initiate response selector 328. The responder indicator 326 may be associated with the user profile 310 and may provide a photo, avatar, or other indicator selected for a user. The initiate response selector 328 may provide an selectable button for the user to initiate the emergency responder input 120. In some aspects, the user must select the initiate response selector 328 to provide the emergency responder input 120. In some alternative aspects, the responder input interface 324 does not require the initiate response selector 328 and instead automatically receives the emergency responder input 120.

FIG. 3E illustrates an exemplary aspect of a simulated caller interface 330. The simulated caller interface 330 may provide the indicator for the simulated caller 170 as providing some prompt or output to the simulated interaction 114. The prompt or output may be provided in a simulated caller output field 332. In some aspects, the simulated caller interface 330 may provide the emergency responder input 120 at the simulated caller output field 332. As the simulated interaction 114 progresses, the simulated caller interface 330 may provide for each of the simulated caller output 126 and the subsequent simulated caller output 134 as provided in the simulated caller output field 332. After a user has evaluated the information presented in the simulated caller output field 332, the user may indicate an option to respond by actively selecting a responder input button 334. The responder input button 334 may indicate to the system 200 that the user is going to respond to the simulated caller 170 and the simulated caller output field 332. In some aspects, the simulated caller interface 330 does not require the active selection of the responder input button 334 to further the simulated interaction 114, and may actively listen or receive any of the emergency responder input 120 or the subsequent emergency responder input 130.

FIG. 3F illustrates an exemplary aspect of a second responder input interface 336. After selection of the responder input button 334, or after the simulated caller 170 has received the emergency responder input 120 or the subsequent emergency responder input 130, the second responder input interface 336 may provide an interface to show the input from the responder indicator 326. The second responder input interface 336 may indicate to the user that the simulated interaction 114 is awaiting or receiving the emergency responder input 120 or the subsequent emergency responder input 130.

It will be understood that the simulated interaction 114 may be carried out through the use input and output of text, audio, video, or a combination thereof. In an exemplary aspect, each of the emergency communication prompt 116, the simulated caller output 126, and the subsequent simulated caller output 134 are provided in both audio and text format, allowing the user to both hear and read outputs from the simulated caller 170. In some aspects, hearing from the simulated caller 170 may include various tones of inflection and emotional states attributed to the first caller disposition 112, the plurality of situational metrics 122, or other similar inputs associated with the simulated caller 170.

FIG. 3G illustrates an exemplary aspect of an interaction review interface 338. The interaction review interface 338 may be accessed via the interactions 314 indicator in the default start screen 302 of the user interface 300. The interaction review interface 338 may provide a list of past interactions and may provide information associated with each of the simulated interaction 114. The interaction review interface 338 may provide a user profile 310 associated with each of the simulated interaction 114. The interaction review interface 338 may include a simulated interaction preview 340, which may provide topical information associated with each of the simulated interaction 114. The simulated interaction preview 340 may indicate information selectable for each of the simulated interaction 114, including simulation roles and call types as described further herein. The simulated interaction preview 340 may also indicate time parameters associated with the simulated interaction 114 and any other measurable parameter desired to be displayed as readily associated with each of the simulated interaction 114 in the interaction review interface 338.

For review in greater detail of the simulated interaction 114, a review simulation indicator 342 may be selectable to expand a portion of the interaction review interface 338 associated with the simulated interaction 114 that is indicated for further review. The review simulation indicator 342 may alter the interaction review interface 338 by increasing the size of the information associated with the simulated interaction 114 relative to the overall size of the interaction review interface 338 and may further provide additional information associated with the simulated interaction 114. For instance, the review simulation indicator 342 may generate an interaction text review pane 344 and various controls 346 associated with the interaction text review pane 344. The interaction text review pane 344 may provide a playback associated with each of the inputs and outputs associated with the simulated interaction 114, including the text associated with each input and output and a progress bar indicator showing how much of each input and output is being provided for review. In an exemplary aspect, the interaction text review pane 344 may replay the inputs and outputs associated with the simulated interaction 114 in both text and audio format, allowing a reviewer or trainer 138 to review the simulated interaction 114 in a substantially similar manner to how the simulated interaction 114 proceeded. The various controls 346 may provide controls for navigating the interaction text review pane 344.

FIG. 3H illustrates an exemplary aspect of a simulation settings interface 348. The simulation settings interface 348 may be accessible through the settings 308 indicator of the user interface 300 and present in the default start screen 302. The simulation settings interface 348 may provide an interface for the selection of settings to be associated at least with the training method 100 or the simulated interaction 114. The settings selection may include a name option 350, a class option 352, a group option 354, a simulation role 356, a simulation call type 358, a mode option 360, a transcription option 362, an automatic calling option 364, a break between calls option 366, and a break between responses option 368.

In some aspects, the name option 350 may include a field to capture the full name of the trainee or the person for whom the training method 100 or simulated interaction 114 settings are being configured. The name option 350 may identify the individual involved in the training method 100 or the simulated interaction 114, and may provide personalized tracking and record-keeping for an individual trainee.

In some aspects the class option 352 may denote the class number associated with the trainee, the training class, any portion of the training method 100, or a combination thereof, the class option 352 may categorize and organize trainees based on their class or batch, and may provide systematic tracking and management of training sessions.

In some aspects, the user interface 300 may allow for system setting of multiple trainees at once. In an exemplary aspect, trainee from multiple classes may be designated by selecting such users in a user settings table. FIG. 3I illustrates an aspect of a user settings panel 370 of the user interface 300 of the present disclosure. The user settings panel 370 may provide much of the same information present through the system settings of the user interface 300, including the name option 350, the class option 352, the transcription option 362, the mode option 360, the simulation role 356, and the simulation call type 358. In addition, the user settings panel 370 may allow for a control lock option 372 for each trainee and may further allow for a selection 374 of each trainee. In this manner, the settings through the user interface 300 may be changed for multiple users at once across different classes.

In some aspects, the group option 354 may include a group to which the trainee belongs and may indicate a team or administrative unit. In some aspects, the group option 354 may indicate the status of the user as a trainee, an administrator, or another party with a specific set of permissions associated with the training method 100 and system 200. The group option 354 may allow for group-based training sessions and facilitate collaboration among trainees within the same group.

In some aspects, the simulation role 356 may include selection of a role that the training method 100 or the simulated interaction 114 may take. The simulation role 356 may define the nature of the simulated interaction 114, which can range from emergency to non-emergency situations, influencing the complexity and type of responses required.

In some aspects, the simulation call type 358 may provide options for a type of call scenario to be simulated. The simulation call type 358 may specify a scenario that will be simulated, tailoring the training to address particular incidents and preparing the trainee for a wide range of situations. In some aspects, the simulation call type 358 may be associated with several of the parameters that may relate to the at least one caller disposition 108, the simulated interaction 114, or other aspects of the training method 100, including exemplary parameters like the plurality of situational metrics 122. Any number and selection of the simulation call type 358 may be available for use in the training method 100, including but not limited to, scenarios like aggressive drivers, medical emergency, home invasion, fire report, missing child, domestic violence, vehicle accident, suspicious activity, natural disasters, animal attacks, overdose, and other potential scenarios that may be included in the training method 100.

In some aspects, the mode option 360 may specify the operational mode of the simulated interaction 114 or the training method 100. The mode option 360 may determine whether the simulated interaction 114 will be controlled manually by the trainer 138 or automatically by the system 200, impacting how the simulated interaction 114 progresses and how interactions are managed. In an exemplary aspects, the mode option 360 may include a manual option, which allows each step of the simulated interaction 114 to be monitored and reviewed before proceeding to the next step of the simulated interaction 114.

In some aspects, the transcription option 362 may include an option to toggle enablement or disable transcription of the simulated interaction 114. The transcription option 362 may determine whether the simulated interaction 114 of the training method 100 will be transcribed.

In some aspects, the automatic calling option 364 may include an option to toggle to enable or disable an automatic calling within the training method 100. The automatic calling option 364 may determine whether the beginning of the simulated interaction 114 begins with a manual prompt to be reviewed and enacted upon by the trainee or the trainer 138 or whether the simulated interaction 114 may begin automatically with an exemplary aspect of the emergency communication prompt 116 or the initial simulated caller input 162.

In some aspects, the break between calls option 366 may include an option to define the amount of time to occur between the end of one simulated interaction 114 and the beginning of another sample caller interactions 144. In an exemplary aspect, the break between calls option 366 may be definable in seconds, minutes, or a combination thereof. In some aspects, the break between calls option 366 may be definable according to an event or other input from the trainer 138 or determined automatically and may not be solely dependent upon a period of time passing between the simulated interaction 114 and the next simulated interaction 114.

In some aspects, the break between responses option 368 may include an option to define an amount of time to occur between responses. In some exemplary aspects, the break between responses option 368 may provide an amount of time to occur between each of the emergency responder input 120, the subsequent emergency responder input 130, and the simulated caller output 126 or subsequent simulated caller output 134. The break between responses option 368 may provide a time between when the trainee finishes an input to the simulated caller 170 and when the simulated caller 170 provides the simulated caller output 126 or the subsequent simulated caller output 134. The break between responses option 368 may similarly be definable in units of measurement of time. In some aspects, the break between responses option 368 may be provided as a variable or range to add some variability to the pace of the simulated interaction 114.

The term “controller” as used herein may refer to at least general-purpose or specific-purpose processing devices, such as a central processing unit, and/or logic as may be understood by one of skill in the art, including but not limited to a microprocessor, a microcontroller, a state machine, and the like. The processor can also be implemented as a combination of computing devices, e.g., a combination of a digital signal processor (DSP) and a microprocessor, a plurality of microprocessors, one or more microprocessors in conjunction with a DSP core, or any other such configuration.

Terms such as “a,” “an,” and “the” are not intended to refer to only a singular entity, but rather include the general class of which a specific example may be used for illustration.

The phrases “in one aspect,” “in some aspects,” “in optional aspect(s),” and “in an exemplary aspect,” or variations thereof, as used herein does not necessarily refer to the same aspect, although it may.

As used herein, the phrases “one or more,” “at least one,” “at least one of,” and “one or more of,” or variations thereof, when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item B and item C.

Conditional language used herein, such as, among others, “can,” “might,” “may,” “e.g.,” and the like, unless specifically stated otherwise, or otherwise understood within the context as used, is generally intended to convey that certain embodiments include certain features, elements, and/or states. The conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Thus, such conditional language is not generally intended to imply that features, elements, and/or states are in any way required for one or more embodiments, whether these features, elements, and/or states are included or are to be performed in any particular embodiment.

The training method 100 may provide the use of the simulated caller and simulated interactions to simulate interactions with callers or suspects, providing realistic training scenarios. The method and system may adapt to different emotional states (distressed, calm, angry, anxious, etc.) and create scenarios on the fly based on real-life examples. This helps trainees practice and improve their skills in handling various types of calls and interactions.

The previous detailed description has been provided for the purposes of illustration and description. Thus, although there have been described particular embodiments of a new and useful invention, it is not intended that such references be construed as limitations upon the scope of this disclosure except as set forth in the following claims. Thus, it is seen that the apparatus of the present disclosure readily achieves the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims.

We claim:

1. A computer-implemented method of training an emergency responder, the method comprising:
compiling a plurality of caller interactions;
generating at least one caller disposition based on the plurality of caller interactions;
selectively assigning a first caller disposition of the at least one caller disposition to a simulated interaction;
based upon the first caller disposition, initiating the simulated interaction through an emergency communication prompt;
comparing an emergency responder input to a plurality of situational metrics associated with the first caller disposition;
adaptively generating a simulated caller output based on the emergency responder input as compared to the plurality of situational metrics associated with the first caller disposition;
iteratively comparing each of a plurality of subsequent emergency responder inputs to the emergency responder input, the plurality of situational metrics associated with the first caller disposition, the simulated caller output, one or more of another of the plurality of subsequent emergency responder inputs, or a combination thereof;
adaptively generating each of a plurality of subsequent simulated caller outputs based on the iterative comparing;
receiving, from a trainer, a trainer review input associated with the simulated interaction; and
modifying a training regiment of the emergency responder based upon the trainer review input.

2. The method of claim 1, wherein compiling the plurality of caller interactions is based upon a dataset of sample caller interactions;
wherein the dataset of sample caller interactions is predetermined by the trainer.

3. The method of claim 1, wherein generating the at least one caller disposition further comprises:
generating the first caller disposition based on a first portion of the plurality of caller interactions; and
generating an alternative caller disposition based on a second portion of the plurality of caller interactions;
wherein the first portion of the plurality of caller interactions is different than the second portion of the plurality of caller interactions.

4. The method of claim 1, further comprising:
generating a caller psychological parameter and a caller situational parameter from the plurality of caller interactions;
modifying one or more of the at least one caller disposition based upon the caller psychological parameter, the caller situational parameter, or a combination thereof; or
modifying the simulated caller output, one or more of the plurality of subsequent simulated caller outputs, or a combination thereof based upon the caller psychological parameter, the caller situational parameter, or a combination thereof.

5. The method of claim 4, wherein:
generating the caller psychological parameter further comprises generating a caller emotional state, a caller behavioral indicator, a cognition function, or a combination thereof; and
generating the caller situational parameter further comprises generating a caller situational awareness, a call characteristic, a social factor, or a combination thereof.

6. The method of claim 2, wherein selectively assigning the first caller disposition to the simulated interaction is based on a trainee-specific data profile, a predetermined trainer profile, or a randomized selection from the dataset of sample caller interactions predetermined by the trainer.

7. The method of claim 1, further comprising:
generating an initial simulated caller input; and
prior to initiating the simulated interaction, presenting the initial simulated caller input to the emergency responder;
wherein the initial simulated caller input comprises a dataset associated with the first caller disposition.

8. The method of claim 7, wherein the dataset associated with the first caller disposition comprises a name indicator, a gender indicator, an ethnicity indicator, a geospatial indicator, or a combination thereof.

9. The method of claim 1, wherein selectively assigning a first caller disposition to a simulated interaction further comprises:
generating a caller morality profile associated with the first caller disposition; and
modifying the simulated interaction with the caller morality profile.

10. The method of claim 1, wherein receiving the trainer review input is based on the emergency responder input, the plurality of subsequent emergency responder inputs, the first caller disposition, the simulated caller output, each of the plurality of subsequent simulated caller outputs, or a combination thereof.

11. The method of claim 1, wherein receiving the trainer review input is based on at least a positive review or a negative review.

12. The method of claim 1, further comprising:
after receiving the trainer review input, repeating the simulated interaction based on the trainer review input.

13. The method of claim 12, further comprising:
selectively assigning a repeat caller disposition, the repeat caller disposition the same as the first caller disposition.

14. The method of claim 1, wherein modifying the training regiment of the emergency responder further comprises selectively assigning a subsequent caller disposition based on the plurality of caller interactions, the subsequent caller disposition being different from the first caller disposition.

15. The method of claim 4, wherein generating the at least one caller disposition or selectively assigning the first caller disposition further comprises:
assigning a caller profile; and
modifying the first caller disposition based on the caller profile;
wherein the caller profile is associated with the plurality of situational metrics associated with the first caller disposition, the caller psychological parameter, the caller situational parameter, or a combination thereof.

16. The method of claim 15, wherein assigning the caller profile is based on a trainee-specific data profile, a predetermined trainer profile, a randomized selection from the plurality of caller interactions predetermined by the trainer, an autonomously generated caller profile associated with the trainer review input, or a combination thereof.
